(19) United States
(12) Patent Application Publication
(10) Pub. No.: US 2021/0127597 A1
(43) Pub. Date: May 6, 2021

(54) WORK ROOM SYSTEM FOR PLANT FACTORY

(71) Applicant: KOREA WHEEL CORPORATION, Ansan-si (KR)

(72) Inventor: Hun CHOE, Boryeong-si Chungcheongnam-do (KR)

(73) Assignee: KOREA WHEEL CORPORATION, Ansan-si (KR)

(21) Appl. No.: 17/105,280

(22) Filed: Nov. 25, 2020

Related U.S. Application Data
(63) Continuation-in-part of application No. PCT/KR2019/008581, filed on Jul. 11, 2019.

(30) Foreign Application Priority Data
Sep. 12, 2018 (KR) 1020180109014
Jun. 7, 2019 (KR) 1020190067522
Nov. 25, 2019 (KR) 1020190152547

(51) Int. Cl. A01G 9/26; B65G 17/20; B65G 43/08; B65G 45/08; A01G 9/24

(52) U.S. Cl. CPC A01G 9/26; B65G 17/20; B65G 2203/0266; B65G 45/08; A01G 9/246; B65G 43/08

(57) ABSTRACT

A plant workshop system for a plant factory that cultivates plants. The plant workshop is disposed adjacent to one or more plant factories that cultivate plants for harvest and/or sale. The workshop includes a building structure having a roof and walls that form an environmental enclosure. A work bench is provided. The adjacent plant factory plant utilizes a trolley conveyor for transport of plants in plant containers. The trolley conveyor is provided with a portion of the trolley conveyor track that enters the workshop, runs adjacent to or over the work bench, and then exits the workshop, thus bringing plants to the work bench for planting, pruning, harvesting, or packaging activities by a worker. Air curtains are provided at the entrance and exit points of the trolley conveyor. A vacuum system is provided for use by the worker in cleaning plant containers. A lubrication oil system is provided for use in providing edible lubrication oil to moving parts of the trolley conveyor. The lubrication oil system may be provided with detectors for automatic sensing of passage of portions of the trolley conveyor, so that oil is provided without the need for worker intervention.

### STATEMENT OF GOVERNMENT INTEREST

Not Applicable.

### COPYRIGHT RIGHTS IN THE DRAWING

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever

### RELATED PATENT APPLICATIONS

This application is a continuation-in-part of PCT KR 2019/008581, filed on Jul. 11, 2019, and published as WIPO Publication No. WO 2020/054958 A1 on Mar. 19, 2020, entitled Trolley Conveyor and Plant Cultivation System Using Same. That PCT application claimed priority from Korean Patent Application 10-2018-0109014, filed Sep. 12, 2018, and Korean Patent Application 10-2019-0067522, filed Jun. 7, 2019. The disclosures of each of PCT KR 2019/008581, Korean Patent Application 10-2018-0109014, and Korean Patent Application 10-2019-0067522, are incorporated herein in their entirety by this reference. Additionally, this application claims foreign priority from Korean Patent Application 10-2019-0152547, filed on Nov. 25, 2019, and published as Korean Published Patent Application No. 10-2137616 on Jul. 20, 2020, the disclosure of which is incorporated herein in its entirety by this reference.

### TECHNICAL FIELD

This disclosure is directed to plant factories for cultivation of plants under controlled growing conditions, and to equipment and systems for handling, growing, harvesting, and packaging plants grown in the plant factory.

### BACKGROUND

In recent years, there has been an increasing interest in plant cultivation in a stable growing environment, where continuity of growing conditions can be maintained without being affected by natural environmental conditions. Thus, there has been increasing interest in plant factories, where plants are grown indoors, and shipped out when mature, and are operated just like factories that produce industrial products. An example of such a plant factory was disclosed in Korean Patent Application Publication No. 10-2017-0025460, published Mar. 8, 2017, with the title Method of Cultivating Spinach Using Light Qualityin a Closed Plant Factory System. However, since the plant factory described cultivates plants at fixed locations in the factory, plants at specific locations which have poor lighting conditions experience degraded growth, compared to the plants at other locations in the plant factory with good lighting conditions. Presently, the solution to this problem involves the hassle of having to change the position of each plant or plant bed in the factory, which requires the worker to move the plants or plant beds around the factory, often one by one. Additionally, since the worker has to have space to move between the plant beds, there is a limit to the number of plants, usually in plant pots or beds, which can be arranged per unit area, since space for the worker to move when arranging the plant pots or beds is required. And, when the plants have completed growth, a worker must go around the factory to retrieve plants and move them to locations for packaging and shipment. Consequently, when the scale of the plant factory is large, a lot of labor is required, so increasing labor costs are problematic, as they increase the required sales price of the plants.

### Some Objects, Advantages, and Novel Features

An object of the invention(s) disclosed herein is to solve the above-described problems caused by the fixed location of plants being grown, and eliminate the requirements for workers to move plants and plant products around the plant factory, by using a trolley conveyor to move the plant pots and beds. In an embodiment, the pots and beds may be automatically transferred by the trolley conveyor, so that all plant pots and beds are exposed to light under the same conditions.

It is yet another object of the invention(s) disclosed herein to provide a plant cultivation system that allows nutrients to be easily supplied to plants, without the need for individual plant attention by workers.

It is yet another object of the invention(s) disclosed herein to provide a plant cultivation system capable of maximizing the number of plants, i.e. plant pots or beds, per unit area. Since, in an embodiment, all plant pots are automatically moved by a trolley conveyor, space for workers to move about the plant factory can be minimized or eliminated.

Another object of the invention(s) disclosed herein to provide for supply of water and nutrients to a plurality of plants in pots or beds, even while connected to a trolley conveyor by hangers. In an embodiment, all plant ports may be circulated together by the drive mechanism of the trolley conveyor. Thus, water supply, nutrient supply, and modification thereof may be made as appropriate for plant cultivation. Importantly, such a plant cultivation system as described herein can significantly minimize labor requirements for plant cultivation, as plants may be moved without handling by workers.

Another object of the invention(s) disclosed herein is to provide a plant cultivation system in which plants brought to a worker for picking and packaging, so that the worker may wait in place, and the plants (or portions thereof to be removed) to be shipped or packaged are supplied to the worker's location, thereby reducing the working time, and labor required for plant packaging.

Another object of the invention(s) disclosed herein is to provide a plant cultivation system capable of efficient transport of plants in the factory, while minimizing noise generation and minimizing production of foreign matter such as dust and dirt, as plants in various units in a plant factory are moved along between locations, such as when being repositioned using the chain portions of a trolley conveyor.

An advantage of the plant workshop system described herein is that it is possible to quickly manage a large number of plant containers, and accordingly, labor productivity is improved.

Another advantage of the plant workshop system described herein is that since a plant vacuum cleaner is provided at the trolley exit side of the workshop, foreign matter that may have fallen into the plant container during the management process can be quickly and easily removed.

And, since a lubricating oil supply unit is provided at the trolley outlet side of the work room to periodically supply lubricating oil to the chain portion of the moving trolley conveyor, smooth operation of the chain portion is assured.

Another advantage of the invention(s) disclosed herein is that the trolley conveyor substantially prevents the lubricating oil supplied to the chain from contaminating plants when the hanger unit is suspended from the trolley conveyor and is moved along by the chain portions of the trolley conveyor.

Finally, it is an advantage of the plant workshop system described herein that a conditioned, enclosed workshop space is provided for use by workers during plant picking and packing projects, by providing an enclosed space having air curtains at the entrance to the workshop, and at the exit of the trolley conveyor from the workshop.

The above objects and various advantages of the invention(s) as disclosed herein will become more apparent from the description provided and details of various embodiments, as will be understood by those skilled in the art.

### SUMMARY

A workshop system for a plant factory is provided. A workshop is located adjacent a plant factory used for cultivating plants for harvest and sale. A workshop is provided as an enclosed space with an entrance for one or more tracks of a trolley conveyor, and exists for one or more tracks of a trolley conveyor. A worktable is provided adjacent or above the one or more tracks within the workspace of the trolley conveyor. A plurality of plant containers are supported for transport to and from the workshop by the trolley conveyor. The workshop may include air curtains at the trolley conveyor entrances and at the trolley conveyor exits, to separate the outside air from the inside air, so that suitable working conditions may be maintained in the workshop. In various embodiments, the tracks for the trolley conveyor may be supported by horizontal support structures such as pipes. Additionally, a vacuum system may be supplied at the worktables for use in cleaning plant containers, as well as the workspace. And a lubricant system may be provided for use in lubrication of the components of the trolley conveyor system. In an embodiment, a lubricating oil supply unit may be provided at the trolley conveyor outlet side of the workroom to periodically supply lubricating oil to the chain portion of the trolley conveyor, to smooth movement of the chain units in the chain portion.

### BRIEF DESCRIPTION OF THE DRAWING

The present invention(s) are described herein by way of exemplary embodiments, using for illustration the accompanying drawing in which like reference numerals denote like elements in the various figures of the drawing, and in which:

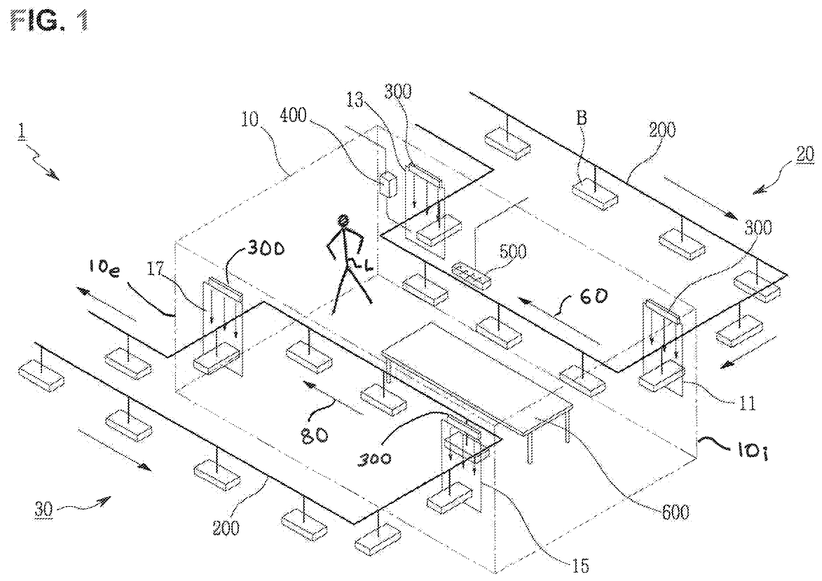

FIG. 1 is a schematic perspective diagram showing the configuration of a plant workshop system as described herein, where the system uses a trolley conveyor system with a fixed track, from which hangers are suspended, and which support plant containers in which plants are grown, for movement between the plant factory and a workshop space, and also illustrating the use of an air curtain to provide a boundary area to separate outside air from air inside the plant workshop.

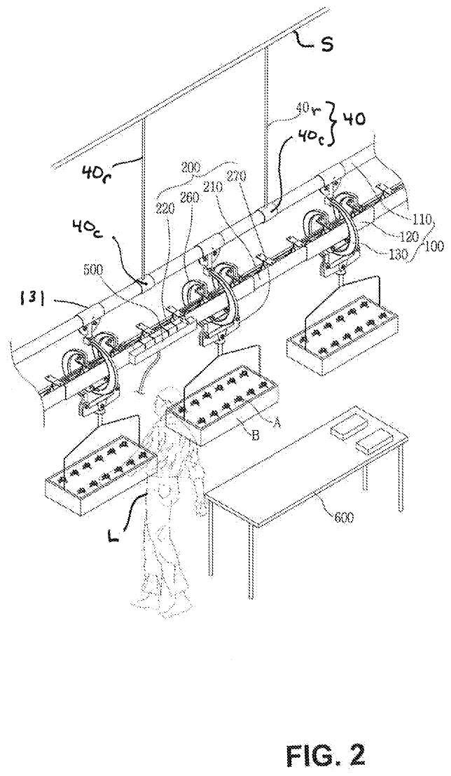

FIG. 2 is a perspective view showing an embodiment for some internal configurations for a plant workshop system, showing a trolley conveyor for circulation of plant containers from the plant factory to a workshop area where a table is located, and also depicting use of a horizontal support, depicted as a circular pipe, from which the track of the trolley system is suspended.

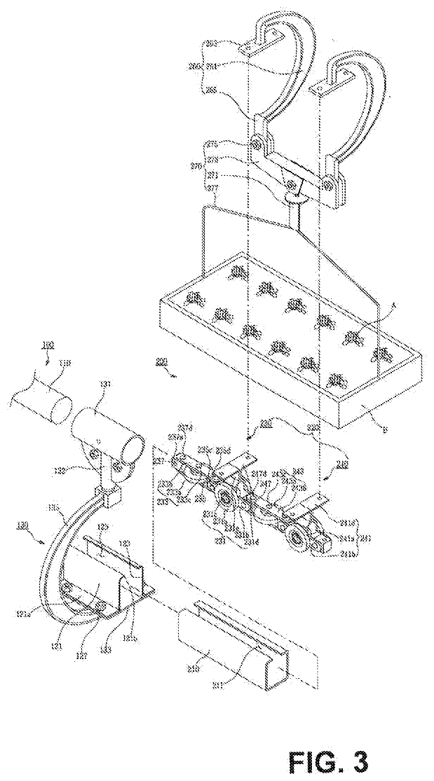

FIGS. 3 through 5 depict embodiments for plant workshop systems for a plant factory, where a trolley conveyor is used for transport of plant containers, and wherein a vacuum system is affixed to and supported above the track used by the trolley conveyor.

FIG. 3 is an exploded perspective view of disassembled key components of an embodiment for a plant workshop using a trolley conveyor, showing a first chain unit part with a substantially horizontal wheel in the chain link, and a second chain unit part with substantially vertically support wheels of the second chain unit part, where the vertical support wheels support the weight of the moveable trolley conveyor, including the first and second chain units, links, and also showing hangers, and a plant container with plants therein, also depicting use of a horizontal support, depicted as a circular pipe, from which the track of the trolley system is suspended.

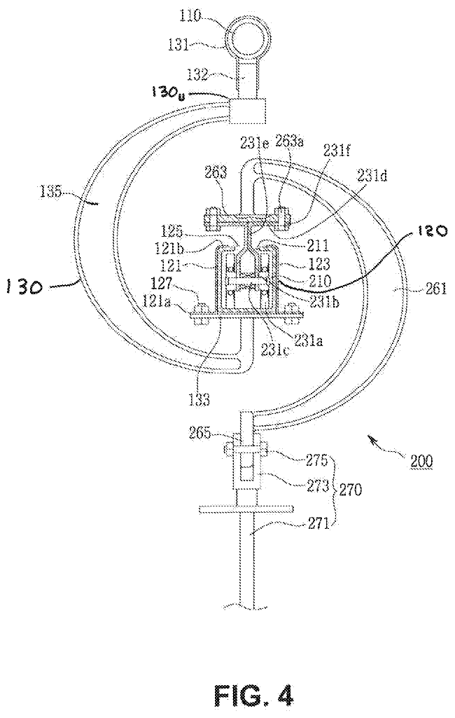

FIG. 4 is a partial cross-sectional view, showing the connection of a hanger with movable components of the trolley conveyor, and showing in cross-section some of the movable components of the trolley conveyor, specifically including the substantially vertical wheels within a stationary slotted tubular track, also depicting use of a horizontal support, depicted as a circular pipe, from which the track of the trolley system is suspended.

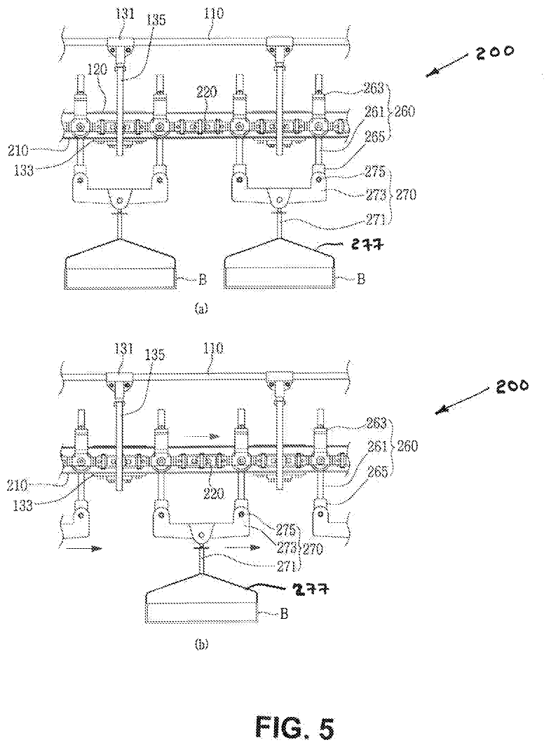

FIG. 5 is a vertical view of key components of an embodiment for a plant workshop using a trolley conveyor, here showing the use of a plant factory having two track levels for the trolley conveyor, with an (a) level above a (b) level, as depicted, but also providing a partially cut away view wherein the closest side of the tubular member forming the track has been cut away from the drawing, in order to show the first chain unit part with a substantially horizontal wheel and chain link, and a second chain unit part with substantially vertically support wheels in the second chain unit part, where the vertical support wheels support the weight of the moveable trolley conveyor, including the first and second chain units, links, and also showing hangers, and a plant containers, also depicting use of a horizontal support, depicted as a circular pipe, from which the track of the trolley system is suspended.

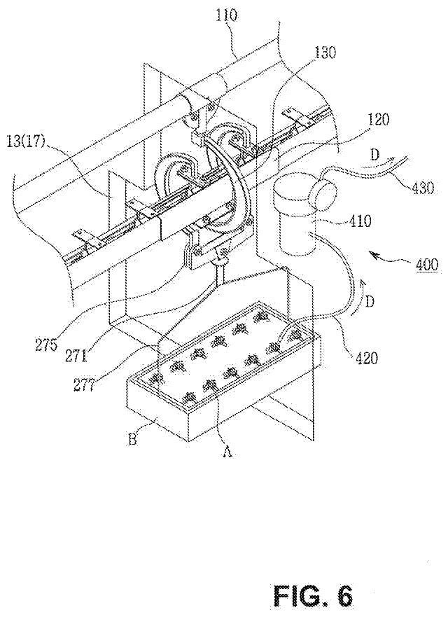

FIG. 6 is a perspective view showing an embodiment for a plant workroom, wherein a vacuum cleaner is provided for use in cleaning plant containers.

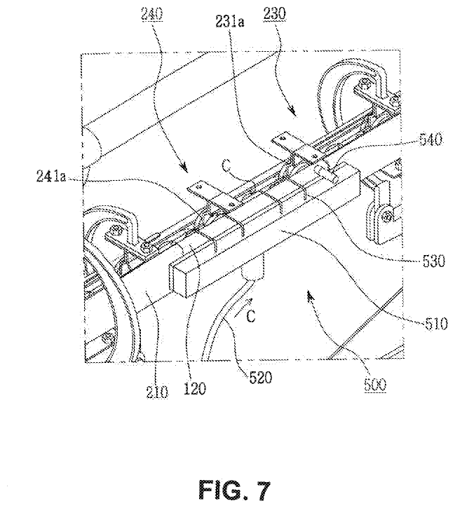

FIG. 7 is a perspective view of a portion of a plant workroom, showing an embodiment for the configuration of a lubricating oil supply unit as used in a plant workshop system as described herein.

The foregoing figures, being merely exemplary, contain various elements that may be present or omitted from a particular final configuration for an embodiment of plant workshop system in a plant cultivation factory. Other variations in trolley system components, and in the supply of workstations for particular needs a workroom for a plan factory for cultivation of plants, such as watering, nutrient supply, pollination, pest control, and disease prevention, may include other mechanical structures, mechanical arrangements, or size and shape of components, and yet employ the principles described herein and as generally depicted in the drawing figures provided, and as more specifically called out in the claims set forth below. Detailed descriptions of configurations and functions of devices known by those of skill in the art are unnecessary, and have thus been omitted. However, there is no intention to limit the claimed invention to dimensional data, and any suggestion provided by any of the drawing figures of this specification are exemplary rather than mandatory. Thus, the chain assembly and related components for links in a trolley conveyor may be provided which is sized up or down from any dimensions depicted, without affecting the scope of the appended claims. An attempt has been made to draw the figures in a way that illustrates at least those elements that are significant for an understanding of exemplary trolley system for carriage of plant containers within a plant factory for efficient cultivation of plants, and particulars may be varied for specific plant production.

It should be understood that various features may be utilized in accord with the teachings hereof, as may be useful in different embodiments, depending upon the specific requirements such as spacing between passageways of runs of a trolley system, all within the scope and coverage of the teachings herein as defined by the claims. Further, like features in various embodiments for a trolley system for use in plant factories may be described using like reference numerals, or other like references, without further mention thereof.

### DETAILED DESCRIPTION

Attention is directed to FIG. 1, where a plant workshop system 1 is provided. A workshop 10 is located in contact with one or more plant factories, such as plant factories 20 and 30. In an embodiment, the workshop 10 may be located between the first plant factory 20 and the second plant factory 30. In some cases, only one plant factory 20 is provided. In other cases, a second plant factory 30 is provided, with each plant factory 20 and 30 adjacent to the workshop 10. In other cases, three plant factories, or more, may be provided. And more than one workshop 10 may be provided as appropriate given the work to be done and the production of the plant factory. In any case, at least one inlet and at least one outlet through which a trolley conveyor can flow into and out of workshop 10 are provided for each plant factory 20, or 30, or the like. Thus, a trolley conveyor 200 is provided that allows a plant container B, such as a tray or pot, to be transported while being suspended in the air along a track (further described below) used by the trolley conveyor 200, for movement to workshop 10 from plant factory 20 and or 30.

An air curtain unit 300 is provided at boundary areas between the plant factory 20 and workshop 10, and between boundary areas between the plant factory 30 and workshop 10. For example, trolley conveyor 200 in plant factory 20, when moving in the direction of reference arrow 60, exits the plant factory 20 at the first plant factory exit 11, and the plant containers B which are being moved by the trolley conveyor 200 pass through an air curtain 300. When plant containers B return to plant factory 20, they pass through first plant factory entrance 13 and pass through an air curtain 300, as they exit the workshop 10. Likewise, trolley conveyor 200 in plant factory 30, when moving in the direction of reference arrow 80, exits the plant factory 30 at the second plant factory exit 15, and the plant containers B which are being moved by the trolley conveyor 200 pass through an air curtain 300. When plant containers B return to plant factory 30, they pass through second plant factory entrance 17 and pass through an air curtain 300, as they exit the workshop 10. In this manner, conditioned air in the workshop 10 is separated from air in the plant factory 20 and/or the plant factory 30, as the case may be, depending on operation of the trolley conveyor 200. In an embodiment, the plant containers B from plant factory 20 and from plant factory 30 may be introduced into workshop 10 at or near the same end, here indicated as 10i in FIG. 1, and may exit from the workshop 20 at or near the opposite end, indicated as end 10e in FIG. 1. In this manner, the trolley conveyor 200 of plant factory 20 and the trolley conveyor 200 of plant factory 30 do not interfere with each other.

In an embodiment a suction system, i.e. an industrial vacuum system 400, may be provided for removal of dirt or other foreign material whether from plant containers B before the plant containers B are returned to the plant 20, or for removal of foreign substances from other parts of workshop 10.

In an embodiment, a lubricating oil supply unit 500 may be provided for supplying lubricating oil to the track 210, and/or the moving components, of the trolley conveyor 200.

In an embodiment, the space inside of workshop 10 may include a working table or work bench 600. A worker L can perform work related to the plant factory 20 or 30, using the work bench 600, such as removal of plants, or parts thereof such as leaves or fruit, from plant containers B, and packing plants, or parts thereof, for shipment. By use of the plant workshop system 1, the amount of labor required from workers L to handle large numbers of plants in plant factories 20 and 30 is significantly reduced. As depicted, a worker L in workshop 10, adjacent the plant factories 20 and 30 where large quantities of plants are grown at the same time, can easily and quickly attend to processing, harvest, and packing of plants A in plant containers B. Workers L in workshop 10 may perform a variety of activities on plants A, such as planting new plants, pruning, crossing, fruit collection, and harvesting leaves, roots or other components of plants A, as well as packaging the plants A and or products thereof for shipment. And, new plants A are easily and quickly placed in plant containers B, when using the workshop 10. Accordingly, it is possible to minimize the total labor required from workers L, and thus manage the plant factories 20 and 30 more efficiently.

Attention is now directed to FIG. 2, where a perspective view showing an interior portion of the workshop 10 is provided. As shown, track mounting 100 components are used to affix the track 210 of the trolley conveyor 200 in a suitable position to carry the plant containers B for transfer between the plant factory 20 and the workshop 10, or between plant factory 30 and the workshop 10. The track mounting components 100 may include a horizontal support 110, a track mount 120, and a track hanger 130, as well as interconnecting components as further discussed below.

The horizontal support 110 may be continuously disposed along a path circulating through a plant factory 20 or 30, and extend out into and through workshop 10. The horizontal support 110 may be provided using pipe of suitable size and strength for the anticipated load. In an embodiment, the horizontal support 110 may be suspended from the interior structure S of the plant factory 20 or 30 by use of pipe hangers 40, which may include rod 40r and pipe clamp 40c.

As seen in FIG. 4, pipe coupler 131 may be used to secure and suspend track 210 from horizontal support 110. A connection shaft 132 extends downwardly from pipe coupler 131 to the upper end 130u of track hanger 130. Thus, the track hanger 130 may be used to connect track 210 of the trolley conveyor 200 to the horizontal support 110. Horizontal supports 110 may be provided in a linear shape, for a straight run of track 210, or in a curved shape, as maybe used to connect two straight runs of track 210. A plurality of track hangers 130 are provided at regular intervals along the longitudinal direction of the horizontal supports 110 to couple the horizontal support 110 and the track mount 120 to each other. As seen in FIG. 4, track hangers 130 are provided with a track seat plate 133 on which track 210 is seated. Track hangers 130 may be provided in a generally C shaped configuration having a coupling arm 135 that connects to the connection shaft 132 of the pipe coupler 131 and the track seat plate 133.

The pipe coupler 131 may be provided with an inner diameter corresponding to the outer diameter of the horizontal supports 110, for ease of fitting to and being secured with the horizontal support 110. The connection shaft 132 provided vertically under the pipe coupler 131 allows vertically length between the horizontal support 110 and the track 210 to be varied. In other words, the connection shaft 132 is used to adjust the distance between the height of horizontal support 110 (which is usually, but not always horizontal, for example, supports 110 may be inclined when used in a multi-story building) and the track 210. In an embodiment, the track hanger 130 may be directly connected to the pipe coupler 131 without use of a connection shaft 132.

The track seat plate 133 is provided in a plate shape having a selected area and width. In an embodiment, the track seat plate 133 is provided with width larger than the width of the track 210. The coupling arm 135 connects the connection shaft 132 and the track seat plate 133. The coupling arm 135 may be formed in a semicircular shape as shown, or may be formed in a “c” shape. As shown in FIG. 4, the upper end 130u of the track hanger 130 is fixedly coupled to the connection shaft 132, and the lower end of the track hanger 130 is fixedly coupled to the plate surface of the track seat plate 133. The track hanger 130 may be integrally coupled to the connection shaft 132 and/or to the track seat plate 133 by a method such as welding.

The track mount 120 is disposed above the track seat plate 133 and fixed thereto to position the track 210 seated on the track seat plate 133, so the track cannot be moved or separated. The track mount 120 includes a first vertical guide plate 121 and a second vertical guide plate 123 positioned left and right on the upper surface of the track seat plate 133. As shown in FIG. 4, the first vertical guide plate 121 and the second vertical guide plate 123 are disposed perpendicular to the upper surface of the track seat plate 133 so as to contact and support both side surfaces of the track 210. Since the first vertical guide plate 121 and the second vertical guide plate 123 are positioned to face each other and have the same configuration, only the first vertical guide plate 121 will be described in detail.

A mounting plate engaging surface 121a is bent to the outside of the track 210 and is provided in a predetermined area under the first vertical guide plate 121. The seating plate coupling surface 121a is configured in contact with the track seating plate 133 and coupled by the coupling member 127. An upper bent end 121b bent inward of the track 210 is provided on the first vertical guide plate 121. The upper bent end 121b is bent toward the top of the track 210 to prevent the track 210 from being separated from the track mount 120.

An opening or hole 125 is formed between the upper bent end 121b of the first vertical guide plate 121 and the second vertical guide plate 123. The opening or hole 125 exposes the opening 211 of the track 210 so that the neck 231e of chain unit 230 and the neck unit of chain unit 240 can be moved along the track 210.

The trolley conveyor 200 is coupled to the horizontal support 110 to enable the transfer the plant containers B to the plant factories 20 and 30 and to the work shop10. The track 210 is fixed by the track mounting components 100 to form a path through which the chain portion 220 is circulated and moved.

In an embodiment, the track 210 may be formed in the shape of a square pipe or tube with an opening 211 formed thereon, as shown in FIG. 3. The opening 211 forms a path through which the neck 231e of the chain portion 220 moves. The chain portion 220 moves along the track 210 and allows the hanger support 260 to which the plant containers B are suspended to move inside the plant factory or the greenhouse.

The chain portion 220 is formed by successively combining a plurality of chain units 230 and chain units 240 as shown in FIG. 3. Since the chain units 230 and 240 have the same configuration, only the first chain unit 230 will be described in detail. The first unit chain 230 is formed by combining a first vertical roller support part 231 and a first horizontal roller support part 233 by a first intermediate connection block 235. The first vertical roller support part 231 includes a pair of first vertical rollers 231a disposed vertically inside the track 210, and a pair of first vertical rollers 231a coupled to the inner surface of the pair of first vertical rollers 231a. A first vertical roller rotation shaft 231c for rotatably supporting a pair of first vertical rollers 231a through the first vertical roller support frame 231b and the pair of first vertical roller support frames 231b. And, a first hanger coupling flange 231d, a first hanger coupling flange 231d and a first vertical roller support frame 231d provided with a certain area in the horizontal direction above the pair of first vertical roller support frames 231b. A first neck 231e connects to first vertical roller support frame 231b.

A pair of first vertical rollers 231a are disposed in a vertical direction inside the track 210 as shown in FIG. 4 to rotate and move along the bottom surface of the track 210. The outer diameter of the first vertical roller 231a is formed to be slightly smaller than the height of the track 210 so as to slide along the inside of the track 210. The first vertical roller rotation shaft 231c passes through the pair of first vertical roller support frames 231b and is coupled to the center of the pair of first vertical rollers 231a. The first vertical roller rotation shaft 231c supports a pair of first vertical rollers 231a to enable idle rotation. To this end, a bearing (not shown) may be provided between the first vertical roller 231a and the first vertical roller rotation shaft 231c. The first vertical roller rotation shaft 231c is provided with a length corresponding slight less than the width of the track 210 so that the pair of first vertical rollers 231a are disposed symmetrically in both directions inside the track 210.

The first neck 231e is formed in the center direction from the top of the pair of first vertical roller support frames 231b and extends upward through the opening 211 of the track 210. The first neck 231e is formed smaller than the opening 211 so that it can be smoothly moved along the opening 211. The first hanger coupling flange 231d is formed to extend a predetermined area horizontally on the upper portion of the first neck 231e and is coupled to the flange coupling plate 263 of the hanger support 260. First fastening holes 231f are formed on both sides of the first hanger coupling flange 231d, and are coupled by the flange coupling plate 263 and the first fastening member 263a.

The first horizontal roller support part 233 includes a first horizontal roller 233a, a pair of first horizontal roller support frames 233b supported above and below the first horizontal roller 233a, and a first horizontal roller support frame. It includes a first horizontal roller rotation shaft 233c rotatably supporting the first horizontal roller 233a with respect to first horizontal roller support frames 233b. The first horizontal roller 233a is located in the horizontal direction of the track 210. The first horizontal roller 233a has an outer diameter corresponding to slight less than the width of the track 210 or is provided at a predetermined length smaller than the width.

The first unit chain 230 is provided in a form in which the first vertical roller support part 231 and the first horizontal roller support part 233 are combined together. The hanger support 260 is provided eccentrically. When the body 261 of hanger support 260 is eccentrically disposed on one side of the track 210 in a “C” shape, and the plant container B is loaded on the plant container support 270 provided under the hanger support 260, it becomes eccentric to one side. That may be problematic, since when the hanger body 261 is eccentric in this way, the chain potion 220 may be inclined to one side inside the track 210 and may not move smoothly within the track 210. Thus, in order to solve this problem, the chain portion 220 as described herein is provided in the form where chain units are joined back to back in a configuration in which vertical rollers and horizontal rollers are alternately arranged.

The track hangar 130 and its coupling arm 135 and the pair of hanger support 260 the hanger body 261 are disposed in opposite directions around the track 210. Such a configuration is, in part, to align the loads along a center of gravity of along both left and right sides so that the chain portion 220 can more stably move along the track 210. In an embodiment, as seen in FIG. 3, in order to match loading along the center of gravity, the track hanger 130 is preferably formed to have a weight corresponding to the weight of the pair of hanger supports 260, as also seen in FIG. 3.

The hanger supports 260 are provided with a horizontal flange 263 at the top. The hanger body 261 may be bent in a “C” or “c” shape. The flange coupling plate 263 is configured for contact with the flange 241d. A bracket coupling plate 265 is provided perpendicular to the lower end of the hanger body 261 and coupled to the hanger coupling bracket 273 of the plant container support 270. The hanger body 261 is disposed on one side of the chain portion 220. The hanger body 261 may be configured to extend from a side of the track 210, although it is centered with track 210 at the upper ends and at the lower end. The flange coupling plate 263 is provided at an area corresponding to the hanger coupling flanges 231d and 241d of each chain units 230 and 240, and configured for stacking on the hanger coupling flanges 231d and 241d, and connected with the first fastening members 263a The bracket coupling plate 265 is disposed vertically under the hanger body 261 and is inserted between the pair of hanger coupling brackets 273 of the plant container support 270. The bracket coupling plate 265 and the pair of hanger coupling brackets 273 are coupled by a second fastening member 275.

As seen in FIG. 3, the plant container support 270 is provided under the hanger support 260 and is coupled to the plant container B. The plant container support 270 is fixedly coupled to the hanger support 260 and supports the plant containers B to be moved in a suspended state by the movement of the chain portion 220. The plant container support 270 includes a pair of hanger coupling brackets 273 coupled with the bracket coupling plate 265 of the hanger support 260 as shown in FIG. 5, and a part extending toward the plant container B. It includes a connection shaft 271 and a coupling frame 277 for coupling the connection shaft 271 and the plant container B.

As seen in FIG. 5, the hanger coupling bracket 273 is provided in a pair, and the bracket coupling plate 265 of the pair of hanger supports 260 are inserted therein. The hanger coupling bracket 273 is provided in a plate shape having a length corresponding to the interval between the pair of hanger supports 260. A pair of bracket coupling plates 265 is inserted between both sides of the hanger coupling bracket 273 and coupled with the hanger coupling bracket 273 by a second fastening member 275. The connection shaft 271 extends a predetermined length toward the lower side from the hanger coupling bracket 273 and supports the plant container coupling frame 277 to be coupled to the plant container B. The plant container coupling frame 277 is branched on both sides from the connection shaft 271 and is fixed to both sides of the plant container B. The connection shaft 271 and the coupling frame 277 may be coupled to each other through welding. The coupling frame 277 may be detachably coupled to the plant container B using a bracket (not shown) and a bolt (not shown).

A pair of first vertical rollers 231a are disposed inside the track 210 on both sides, and the first vertical rollers 231a move while contacting the bottom surface of the track 210. The pair of first vertical rollers 231a move along the bottom surface of the track 210 and support a vertical load. When the first horizontal roller 233a is moved along the inside of the track 210, it is rotated by contacting the inner wall surfaces of sides of the track 210, and thus the chain portion 220 is not eccentric in one direction and can be moved in a balanced fashion.

The first vertical roller support part 231 and the second vertical roller support part 241 are coupled by an intermediate connection block 235. The intermediate connection block 235 is coupled between a pair of first vertical roller support frames 231b and a pair of first horizontal roller support frames 233b. The intermediate connection block 235 may be provided in the form of a rectangular parallelepiped block. In the intermediate connection block 235, a first intermediate horizontal connection shaft insertion hole 235a is formed therethrough in a horizontal direction, and a first intermediate vertical connection shaft insertion hole 235b is formed therethrough a vertical direction. The first intermediate horizontal connection shaft 235c is inserted through the pair of first horizontal roller support frames 233b disposed on the left and right into the first intermediate horizontal connection shaft insertion hole 235a. The first intermediate vertical connection shaft 235d is inserted into the first intermediate vertical connection shaft insertion hole 235b through a pair of first vertical roller support frames 231b arranged vertically.

When the first vertical roller support part 231 and the second vertical roller support part 241 are combined with each other and move along the track 210 by the connection structure of the intermediate connection block 235, the first vertical roller support part 231) And the second vertical roller support part 241 may be rotated vertically around the first intermediate horizontal connection shaft 235c, and may rotate left and right around the first intermediate vertical connection shaft 235d. Accordingly, the chain portion 220 not only moves smoothly through the straight track 210, but can also move smoothly through the curved track portions. Further, a first end connection block 237 is provided at a rear end of the first horizontal roller support part 233. The first end connection block 237 is used to connect to a chain unit located in front of the first chain unit 230. The first unit chain 230 and the second unit chain 240 are coupled by a second end connection block 247. The second end connection block 247 is provided between the first vertical roller support frame 231b of the first unit chain 230 and the second horizontal roller support frame 243b of the second unit chain 240. The first vertical roller support frame 231b is coupled to be rotatable up and down by a second end connection block 247 and a second end horizontal connection shaft and the second horizontal roller support frame 243b at a second end. The connection block 247 and the second end vertical connection shaft are coupled for left and right rotation. Consequently, the chain units 230 and 240 are configured adjacent to each other and are coupled to each other so as to be able to rotate up and down and left and right at the first end connection blocks 237 and 247. The chain portion 220 to which the chain units 230 and 240 are continuously coupled can smoothly move through portion of track 210 of various shapes.

The horizontal rollers and vertical rollers alternately provided in each of the chain units 230 and 240 are in contact with the bottom surface and the inner surface of the track 210 and can be moved in balance without being eccentric. Accordingly, the first neck 231e does not come into contact with an edge of the opening 211 of the track 210 when the chain portion 220 is be moved. Thus, this avoids generating noise or foreign matter when the chain portion 220 is moved.

The chain portion 220 is driven by a chain driving units may be provided around the track 210 at regular intervals so that the chain portion 220 moves smoothly. The chain driving unit (not shown) may include an electric motor and a drive unit that transmits power from the motor to the chain portion 220. The chain drive unit may be controlled via a control signal from a control unit (not shown).

An air curtain unit 300 may be provided at the trolley entrances to the workroom 10 at the first plant factory exit 11 and at the exit from the workroom 10 at the first plant factory entrance 15. Similarly, an air curtain unit 300 may be provided at trolley entrance to the workroom 10 at the second plant factory exit 13 and at the trolley exit from workroom 10 at the second plant factory entrance 17, as shown in FIG. 1 to block air inside and outside of the workshop 10. Accordingly, when the plant containers B flow into workroom 10, through the first plant factory exit 11 and through the second plant factory exit 15 via the trolley conveyor 200, the temperature inside the workshop 10 remains controlled at a setpoint temperature, and thus is not normally changed. As a result, inside the workshop 10, air conditioning equipment such as an air conditioner and a heater are installed so that a worker L can work in a comfortable state. In this manner, it is possible to block the temperature inside the plant factories 20 and 30 from affecting the workshop 10 environment conditions.

In an embodiment, an industrial plant vacuum cleaner 400 may be disposed at the trolley outlets 13 and 17 to remove foreign substances generated in the plant container B while working in the workshop 10. FIG. 6 provides an exemplary view showing a process of cleaning the plant container B by the plant vacuum cleaner 400. As shown, the plant vacuum cleaner 400 includes an operating power chamber 410 for forming a suction pressure, a suction pipe 420 extends from the operating power chamber 410 to suck foreign substances D from the plant containers B, via a foreign substance suction line 420. A foreign material discharge pipe 430 may be provided for discharging to the outside any foreign material D sucked through suction line 420.

In the workshop 10, the worker L may supply water to the plants A planted in the plant containers B, remove withered leaves, or performs pruning. Accordingly, during handling, water may accumulate in the plant container B, or leaves or removed branches may be detached. In an embodiment, the plant vacuum system 400 may be a wet/dry type vacuum. Thus, when the worker uses the foreign substance suction line 420, a suction is placed on the surface of the plant container B (or may be used on other surfaces), and foreign substances D and drained water, for example from the plant container B, may be removed. The foreign matter discharge pipe 430 may connected outside of the workshop 10 to discharge foreign matter to the outside.

Attention is directed to FIG. 7, where a lubricating oil supply unit 500 is depicted. The lubricating oil supply unit 500 may be provided to supply lubricating oil to the chain portion 220 of the trolley conveyor 200. The lubricating oil supply unit 500 may be coupled to the side of the track mount 120 of the track support mounting components 100. The lubricating oil supply unit may be moved along the track mount 120. Use of lubricating oil allows the chain portion 220 to move smoothly. As shown, the lubricating oil supply unit 500 includes a rail coupling frame 510 coupled to the side of the track mount 120, a lubricating oil supply line 520 for supplying lubricating oil to the rail coupling frame 510, and a lubricating oil supply pipe. A plurality of lubricating oil supply nozzles 530 may be provided connected to the lubricating oil supply line 520. Lubricating oil may be provided at the top of the track 210, and to vertical rollers of each chain unit 230 and 240 of the chain portion 220. The lubricating oil supply unit 500 may also include an approach detection sensor 540 for sensing the approach of the vertical rollers 231a and 241a in chain units 230 and 240. Also, when the lubricating oil falls into the plant container B, edible oil is used so that it is not harmful even if humans consume the oil, since it may end up being buried in the plant container, and thus may potentially be available for update by the plants A. When the approach detection sensor 540 detects the vertical rollers of each chain unit, the plurality of lubricating oil supply nozzles 530 supply lubricating oil C to the chain portion 220, especially at locations around the vertical rollers. In an embodiment, the lubricating oil supply nozzles 530 supply the lubricating oil C in a dropwise manner to minimize the flow of excess lubricating oil C into objects below, such as the plant containers B. Lubricating oil C may be supplied from a lubricating oil storage tank (not shown) via a lubricating oil supply line 520. From there, lubricating oil C is supplied to the surface of each chain unit through the lubricating oil supply nozzle 530. When cleaning and supply of lubricating oil C is completed, the trolley conveyor 200 is driven again, and the chain portion 220 in which the managed plant containers B are located is returned to the plant factories 20 and 30.

When the trolley conveyor 200 is moved to the workshop 10, the worker L may turn the drive for the chain portion of the trolley conveyor 200 on or off, or may adjust the working speed. In an embodiment, the lubricating oil supply unit 500 supplies lubricating oil to each of the unit chains of the trolley conveyor 200, which as they pass through the trolley outlets 13 and 17 of the work shop 0 and is moved to the plant factories 20 and 30. When the management of the plants A in the plant containers B is completed, the worker L drives the trolley conveyor 200 and the plant containers B on which the work is completed to a desired location, and brings in new plant containers B for work.

While the present invention(s) for a plant workshop system 1 have been described for use with a single story building, that is only an example, A plant workshop system may be provided on each floor of a multi-story plant factory. Or, a plurality of plant workshop systems 1 may be provided on each, or one or more floors, of a multi-floor building. And, a plant workshop system 1 may be provided in the middle on the path of the trolley conveyor 200, as well as at the end of a trolley conveyor 200, when the scale of a plant factory is large.

Although only a few exemplary embodiments have been described in detail, various details are sufficiently set forth in the drawings and in the specification provided herein to enable one of ordinary skill in the art to make and use the invention(s), which need not be further described by additional writing in this detailed description. It will be readily apparent to those skilled in the art that the plant workshop system 1, and the plant factory 20 and 30 details as described herein, may be modified from those embodiments provided herein, without materially departing from the novel teachings and advantages provided.

The aspects and embodiments described and claimed herein may be modified from those shown without materially departing from the novel teachings and advantages provided, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. A factory workshop, the factory workshop adjacent one or more plant cultivation facilities, wherein the plant cultivation facilities comprise at least one trolley conveyor with moving chain portions having hangers therefrom which support plant containers in which workpiece plants are provided, the factory workshop comprising:
a building structure, the building comprising walls, a roof, and internal load supporting elements, and forming an environmental enclosure having a conditioned space therein, the building structure having a trolley conveyor entrance and trolley conveyor exit;
a trolley conveyor, the trolley conveyor comprising
a stationary track extending from the trolley conveyor entrance to the trolley conveyor exit, the track supported by hangers from the internal load supporting elements,
a chain portion, the chain portion configured for rolling movement within the conveyor track when urged along by a chain drive unit,
a plurality of plant hangers, the plant hangers suspended from the chain portion and configured for movement therewith,
a plurality of plant containers supported by the plant hangers,
a work bench, the work bench located adjacent or under a portion of the stationary track of the trolley conveyor,
controls operable by a worker in the factory workshop to direct movement of the chain portion of the trolley conveyor, the controls including start, stop, and speed controls;
an air curtain at the trolley conveyor entrance and at the trolley conveyor exit, the air curtain operable to effectively prevent migration of air between locations inside and outside of the environmental enclosure, so as to maintain existing environmental conditions in the conditioned space; and
a vacuum system, the vacuum system configured adjacent the workbench for use by worker when handing plants passing through the workshop on the trolley conveyor.

2. The factory workshop as set forth in claim 1, wherein the conditioned space is maintained at a setpoint temperature with air conditioning equipment.

3. The factory workshop as set forth in claim 1, wherein the conditioned space is maintained at a setpoint temperature with heating apparatus.

4. The factory workshop as set forth in claim 1, further comprising a lubrication system, and wherein the lubrication system is configured to automatically provide lubrication oil to the at least some of the chain portions as the chain portions pass through the factory workshop.

5. The factory workshop as set forth in claim 4, wherein the lubrication oil comprises edible oil.

6. The factory workshop as set forth in claim 1, wherein the vacuum system comprises a vacuum source and an outlet, and wherein the outlet is located outside of the conditioned space.

7. The factory workshop as set forth in claim 6, wherein the vacuum system comprises a wet vacuum, and wherein the vacuum system is operable for removal of water from the conditioned space.

8. The factory workshop as set forth in claim 1, wherein the plurality of plant containers are configured for material transfer to the factory workshop of plants for harvest or sale.

9. The factory workshop as set forth in claim 8, wherein the work bench is adapted for packaging of plants or plant materials for shipment.

10. A workshop for work on plants during planting, growth, or harvest, the work room disposed adjacent to factories for growing plants, the work room comprising:
a work bench;
trolley conveyor entrances and trolley conveyor exits;
a trolley conveyor, the trolley conveyor having a stationary track portion and a moveable chain portion,
the stationary track portion located and configured for circulation via the moveable chain portion of plants from the plant factories to the work room of while the plants are suspended from the trolley track;
an air curtain units provided at the trolley entrances and the trolley exits, the air curtain units configured and operated to block flow of internal and external air to or from the work room, so as to maintain a constant temperature in the work room; and
a vacuum system, the vacuum system configured adjacent the work bench for use by workers when handing plants passing through the workshop on the trolley, the vacuum system operable to remove foreign matter and discharging foreign matter through an outlet pipe external to the work room.

11. A work room as set forth in claim 1, further comprising a lubricating oil supply system, the lubrication oil supply system comprising:
a lubricating oil supply unit for supplying lubrication oil;
a coupling frame configured for coupling the lubrication oil supply unit to a track support of the trolley conveyor;
a lubrication oil storage tank;
a supply line that supplies lubrication oil to the lubrication oil supply unit; and
an automatic sensing mechanism, and oil spray nozzles responsive to the automatic sensing mechanism, wherein the automatic sensing mechanism is operative to sense passage of at least some of the chain portion past the automatic sensing mechanism, and to lubricate the chain portions.

12. The factory workshop as set forth in claim 11, wherein the automatic sensing mechanism comprises an approach access detection sensor, so that the lubrication oil system is activated when a chain portion approaches the lubrication oil system, and wherein a plurality of oil supply nozzles are used for supply of lubrication oil to the chain portions.
